(19) United States
(12) Patent Application Publication
(10) Pub. No.: US 2008/0152841 A1
(43) Pub. Date: Jun. 26, 2008

(54) Contact Adhesives for Printable Paper Labels

(75) Inventors: Nok-young Choi, Herzogenrath (DE); Heiko Diehl, Fussgonheim (DE); Andree Dragon, Speyer (DE); Stefan Kirsch, Nieder-Olm (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, LUDWIGSHAFTEN (DE)

(21) Appl. No.: 11/814,578

(22) PCT Filed: Feb. 1, 2006
(86) PCT No.: PCT/EP06/50603

§ 371 Date: Jul. 24, 2007

(30) Foreign Application Priority Data
Feb. 2, 2005 (DE) 10-2005-004-925.7

(51) Int. Cl. C08G 67/00

(52) U.S. Cl. 427/596; 526/329.5; 528/271; 428/481

(57) ABSTRACT

A pressure-sensitive adhesive comprising a polymer obtainable by free-radical polymerization and synthesized from
a) 70% to 99% by weight of n-butyl acrylate
b) 1% to 30% by weight of ethylhexyl acrylate
c) 0 to 5% by weight of an ethylenically unsaturated acid
d) 0 to 20% by weight of at least one further monomer, for which vinyl acetate is excluded.

The invention relates to a pressure-sensitive adhesive comprising a polymer obtainable by free-radical polymerization and synthesized from
a) 70% to 99% by weight of n-butyl acrylate
b) 1% to 30% by weight of ethylhexyl acrylate
c) 0 to 5% by weight of an ethylenically unsaturated acid
d) 0 to 20% by weight of at least one further monomer, for which vinyl acetate is excluded.

The invention further relates to self-adhesive articles, especially printable paper labels, which have been coated with the pressure-sensitive adhesive.

Pressure-sensitive adhesives (PSAs) form a permanently tacky film which adheres, as their name suggests, even under gentle pressure at room temperature to any of a very wide variety of surfaces. PSAs serve for producing self-adhesive products such as self-adhesive labels, tapes or sheets. Such products are very easy to use and enable rapid working on bonding. The quality of a self-adhesive article depends essentially on whether the internal strength (cohesion) and the attachment of an adhesive film to the surface where bonding is to take place (adhesion) have been harmonized with one another in accordance with the respective application.

The desire is in particular for PSAs suitable for different uses.

An additional tackifying resin (tackifier) is often added to the PSAs.

The PSA must then have a good adhesion/cohesion balance despite the addition of tackifier.

Many paper labels are printed. In printers, laser printers for example, high temperatures occur. Consequently the PSAs should not be ever so fluid and in particular they ought to retain their good cohesion at high temperatures, in order to prevent oozing from the edges and contamination of the printer. For the subsequent bonding of the printed label at room temperature the adhesion in particular ought to be good.

In particular it is also intended that the PSAs should be odorless.

Vinyl acetate polymers give off acetic acid, particularly at high temperatures, leading to instances of odor nuisance.

EP-A 952 199 discloses PSAs comprising polymers of n-butyl acrylate and 2-ethylhexyl acrylate. n-Butyl acrylate is used here only in minor amounts.

WO 00/36039 describes PSAs suitable for high-temperature uses, for printable labels, for example.

An object of the present invention were PSAs and self-adhesive articles which have the above properties. Found accordingly are the PSAs defined at the outset.

The PSAs of the invention comprise as essential constituent a polymer obtainable by free-radical polymerization and synthesized from
a) 70% to 99% by weight of n-butyl acrylate
b) 1% to 30% by weight of ethylhexyl acrylate
c) 0 to 5% by weight of an ethylenically unsaturated acid
d) 0 to 20% by weight of at least one further monomer, for which vinyl acetate is excluded.

Examples of suitable monomers c) include monomers with carboxylic acid, sulfonic acid or phosphoric acid groups. Monomers with carboxylic acid groups are preferred. Examples that may be mentioned include acrylic, methacrylic, itaconic, maleic, and fumaric acid. Of particular preference is acrylic or methacrylic acid.

Further monomers d) are, for example, C1-C20 alkyl (meth)acrylates (apart from nBA and EHA), vinyl aromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds, or mixtures of these monomers.

Examples include methyl methacrylate, methyl acrylate, and ethyl acrylate.

Suitable vinyl aromatic compounds include vinyltoluene, a- and p-methylstyrene, a-butylstyrene, 4-n-butylstyrene, 4-n-decylstyrene, and, preferably, styrene. Examples of nitrites are acrylonitrile and methacrylonitrile.

The vinyl halides are ethylenically unsaturated compounds substituted by chlorine, fluorine or bromine, preferably vinyl chloride and vinylidene chloride.

Examples of vinyl ethers include vinyl methyl ether and vinyl isobutyl ether. Preference is given to vinyl ethers of alcohols comprising 1 to 4 carbon atoms.

As hydrocarbons having 4 to 8 carbon atoms and two olefinic double bonds mention may be made of butadiene, isoprene, and chloroprene.

Further monomers are also, for example, monomers comprising hydroxyl groups, especially C₁-C₁₀ hydroxylalkyl (meth)acrylates, and (meth)acrylamide.

As further monomers mention may be made, moreover, of phenyloxyethyl glycol mono(meth)acrylate, glycidyl acrylate, glycidyl methacrylate, and amino (meth)acrylate such as 2-aminoethyl (meth)acrylate.

As further monomers mention may also be made of crosslinking monomers.

Preferably the polymer is synthesized from
a) 75% to 95% by weight of n-butyl acrylate
b) 5% to 25% by weight of ethylhexyl acrylate
c) 0 to 5% by weight of an ethylenically unsaturated acid
d) 0 to 5% by weight of at least one further monomer, for which vinyl acetate is excluded.

With particular preference the polymer is synthesized from
a) 75% to 94.5% by weight of n-butyl acrylate
b) 5% to 24.5% by weight of ethylhexyl acrylate
c) 0.5% to 5% by weight of an ethylenically unsaturated acid
d) 0 to 10% by weight of at least one further monomer, for which vinyl acetate is excluded.

With very particular preference the polymer is synthesized from
a) 80% to 89% by weight of n-butyl acrylate
b) 10% to 19% by weight of ethylhexyl acrylate
c) 1% to 2% by weight of an ethylenically unsaturated acid
d) 0 to 5% by weight of at least one further monomer, for which vinyl acetate is excluded.

In one preferred embodiment the polymers are prepared by emulsion polymerization and the product is therefore an emulsion polymer.

For emulsion polymerization use is made of ionic and/or nonionic emulsifiers and/or protective colloids and/or stabilizers as surface-active compounds.

A detailed description of suitable protective colloids is found in Houben-Weyl, Methoden der organischen Chemie, Volume XIV/1, Makromolekulare Stoffe [Macromolecular compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are normally below 2000 g/mol. Where mixtures of surface-active substances are used the individual components must of course be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO units: 3 to 50, alkyl radical: C₈ to C₃₆), ethoxylated mono-, di- and tri-alkylphenols (EO units: 3 to 50, alkyl radical: C₄ to C₉), alkali metal salts of dialkyl esters of sulfosuccinic acid and also alkali metal salts and ammonium salts of alkyl sulfates (alkyl radical: C₈ to C₁₂), of ethoxylated alkanols (EO units: 4 to 30, alkyl radical: C₁₂ to C₁₈), of ethoxylated alkylphenols (EO units: 3 to 50, alkyl radical: C₄ to C₉), of alkylsulfonic acids (alkyl radical: C₁₂ to C₁₈) and of alkylarylsulfonic acids (alkyl radical: C₉ to C₁₈).

Further suitable emulsifiers are compounds of the general formula II

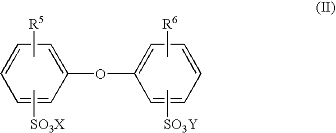

in which R⁵ and R⁶ are hydrogen or C₄ to C₁₄ alkyl and are not simultaneously hydrogen, and X and Y can be alkali metal ions and/or ammonium ions. With preference R⁵ and R⁶ are linear or branched alkyl radicals having 6 to 18 carbon atoms or hydrogen and in particular have 6, 12 and 16 carbon atoms, R⁵ and R⁶ not both simultaneously being hydrogen. X and Y are preferably sodium, potassium or ammonium ions, sodium being particularly preferred. Particularly advantageous compounds II are those in which X and Y are sodium, R⁵ is a branched alkyl radical having 12 carbon atoms, and R⁶ is hydrogen or R⁵. It is common to use technical mixtures which include a fraction of 50% to 90% by weight of the monoalkylated product, one example being Dowfax® 2A1 (trade name of the Dow Chemical Company).

Suitable emulsifiers are also found in Houben-Weyl, Methoden der organischen Chemie, Volume 14/1, Makromolekulare Stoffe, Georg Thieme Verlag, Stuttgart, 1961, pages 192 to 208.

Examples of emulsifier trade names include Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil® FES 77, Lutensol® AT 18, Steinapol VSL, and Emulphor NPS 25.

For the present invention preference is given to ionic emulsifiers or protective colloids. Ionic emulsifiers are particularly preferred, especially salts and acids, such as carboxylic acids, sulfonic acids, and sulfates, sulfonates or carboxylates.

The surface-active substance is usually used in amounts of 0.1 to 10 parts by weight, preferably 0.2 to 5 parts by weight, per 100 parts by weight of the monomers to be polymerized.

Water-soluble initiators for the emulsion polymerization are, for example, ammonium and alkali metal salts of peroxidisulfuric acid, e.g., sodium peroxodisulfate, hydrogen peroxide or organic peroxides, e.g., tert-butyl hydroperoxide.

Also suitable are what are known as reduction-oxidation (redox) initiator systems.

The redox initiator systems are composed of at least one, usually inorganic, reducing agent and one organic or inorganic oxidizing agent.

The oxidizing component comprises, for example, the emulsion polymerization initiators already mentioned above.

The reducing components comprise, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems include ascorbic acid/iron(II) sulfate/sodium peroxidisulfate, tert-butyl hydroperoxide/sodium disulfite, tert-butyl hydroperoxide/Na hydroxymethanesulfinic acid. The individual components, the reducing component for example, may also be mixtures: for example, a mixture of the sodium salt of hydroxymethanesulfinic acid and sodium disulfite.

The stated compounds are mostly used in the form of aqueous solutions, the lower concentration being determined by the amount of water that is acceptable in the dispersion and the upper concentration by the solubility of the respective compound in water. In general the concentration is 0.1% to 30% by weight, preferably 0.5% to 20% by weight, more preferably 1.0% to 10% by weight, based on the solution.

The amount of the initiators is generally 0.1% to 10% by weight, preferably 0.5% to 5% by weight, based on the monomers to be polymerized. It is also possible for two or more different initiators to be used for the emulsion polymerization.

For the polymerization it is possible to use regulators, in amounts for example of 0 to 0.8 parts by weight, per 100 parts by weight of the monomers to be polymerized; these regulators lower the molar mass. Suitable examples include compounds with a thiol group such as tert-butyl mercaptan, thioglycolic acid ethylacrylic esters, mercaptoethynol, mercaptopropyltrimethoxysilane or tert-dodecyl mercaptan.

The emulsion polymerization takes place in general at 30 to 130, preferably 50 to 90° C. The polymerization medium may be composed either of water alone or of mixtures of water and water-miscible liquids such as methanol. Preferably only water is used. The emulsion polymerization may be conducted either as a batch operation or in the form of a feed process, including staged or gradient procedures. Preference is given to the feed process, in which a portion of the polymerization mixture is introduced as an initial charge and heated to the polymerization temperature, the polymerization of this initial charge is begun, and then the remainder of the polymerization mixture is supplied to the polymerization zone, usually by way of two or more spatially separate feed streams, of which one or more comprise the monomers in neat or emulsified form, this addition being made continuously, in stages or under a concentration gradient, and polymerization being maintained during said addition. It is also possible, in order, for example, to set the particle size more effectively, to include a polymer seed in the initial charge for the polymerization.

The monomers are generally added in the form of aqueous emulsions. In one version of the process up to 20% by weight, in particular up to 10% by weight, of the monomers at the end of the polymerization are added not in the form of an emulsion (swelling polymerization).

The manner in which the initiator is added to the polymerization vessel in the course of the free-radical aqueous emulsion polymerization is known to the skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove the residual monomers it is common to add initiator after the end of the actual emulsion polymerization as well, i.e., after a monomer conversion of at least 95%, and to subject the dispersion to afterpolymerization, i.e., to maintain it at the polymerization temperature for some additional time.

In the case of the feed process the individual components can be added to the reactor from the top, through the side, or from below, through the reactor floor.

In the case of emulsion polymerization, aqueous dispersions of the polymer with solids contents of generally 15% to 75%, preferably of 40% to 75%, by weight are obtained.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81083), by adding excess quantities of emulsifier, or by adding miniemulsions. Another advantage associated with the low viscosity at high solids content is the improved coating performance at high solids contents. One or more new generations of particles can be produced at any point in time. It is guided by the particle size distribution which is targeted for a low viscosity.

The polymer thus prepared is used preferably in the form of its aqueous dispersion.

The pH of the polymer dispersion is preferably set at a pH of more than 4.5, in particular at a pH of between 5 and 8.

The glass transition temperature of the polymer, or of the polymer, is preferably −60 to 0° C., more preferably −60 to −10° C., and very preferably −60 to −20° C.

The glass transition temperature can be determined by customary methods such as differential thermoanalysis or differential scanning calorimetry (see, for example, ASTM 3418/82, midpoint temperature).

The PSAs of the invention may be composed solely of the polymer or of the aqueous dispersion of the polymer.

The PSAs may comprise further additives, examples being fillers, colorants, flow control agents, thickeners or tackifiers (tackifying resins). Examples of tackifiers are natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene.

Other compounds increasingly being used as tackifiers include polyacrylates which have a low molar weight. Preferably these polyacrylates have a weight-average molecular weight M_{w} of below 30 000. With preference the polyacrylates are composed of at least 60%, in particular at least 80%, by weight of C₁-C₈ alkyl (meth)acrylates.

Preferred tackifiers are natural or chemically modified rosins. Rosins are composed predominantly of abietic acid or derivatives thereof.

Preferably the PSA comprises tackifiers, especially rosins.

The amount by weight of the tackifiers is preferably 5 to 100 parts by weight, more preferably 10 to 50 parts by weight, per 100 parts by weight of polymer (solids/solids).

The adhesives preferably comprise flow control agents (e.g., Lumiten) in amounts of 0.05 to 3 parts by weight per 100 parts by weight of polymer. As flow control agents or wetting agents suitability is possessed in particular by sulfonated dicarboxylic esters. Particular preference is given to dialkyl esters of sulfonated succinic acid, such as are described in EP 1 006 106. Wetting agents are often useful in transfer application methods, since in the case of these methods first siliconized paper is coated, to which the PSA does not adhere well. This is followed by transfer onto the desired backing material.

The PSAs of the invention are especially suitable for producing self-adhesive articles, such as labels, adhesives tapes or cohesive sheets, protective sheets for example.

The self-adhesive articles are generally composed of a backing and of a layer of the adhesive applied on one or both sides, preferably one side.

The backing material may comprise, for example, paper or polymeric films, made from polyolefins or PVC. Paper is preferred.

To produce the layer of adhesive on the backing material the backing material can be coated conventionally, including, for example, by a transfer method. Customary coat thicknesses (after drying) are 5 to 30 g/m², for example.

The coated substrates obtained are used, for example, as self-adhesive articles, such as labels, adhesive tapes or sheets. Labels are preferred, especially printable labels.

The self-adhesive articles, especially labels, may be bonded to any desired substrates, particularly those made from polyolefins, paper or cardboard.

With and without the addition of tackifiers, the PSAs of the invention have good cohesion and adhesion. They are also odorless at high temperatures.

The self-adhesive articles are especially suitable for utilities in which they are exposed to high temperatures of more than 50° C., or 80° C., in particular more than 100° C., such as the printing of labels, particularly with a laser printer.

During the slitting or diecutting of PSA-coated backings, labels for example, there is no—or virtually no—oozing of adhesive from the edges. Even at high temperatures, such as occur, for example, when printing self-adhesive articles, particularly labels, in a laser printer, there are no observable instances of contamination due to edge oozing or stringing of the adhesive.

The PSAs have good adhesion and cohesion at room temperature, even, in particular, on nonpolar surfaces, and have good cohesion at high temperatures, thereby preventing contamination and edge oozing.

### EXAMPLES

### A) Preparation of the Polymer Dispersions

The polymers were prepared in a 1-liter three-neck flask with reflux condenser under a nitrogen atmosphere.

83 g of deionized water, 5.3 g of a 33% by weight polystyrene seed, and 50 g of an initiator solution (7% Na peroxodisulfate in water) were heated to 65° C. At 80° C. a mixture of 4.67 g of a 15% strength aqueous ammonia solution and 10.5 g of a 10% strength solution of sodium hydroxymethylsulfonate (Rongalit®C) and 59 g of deionized water was added over a period of 190 minutes.

10 minutes after the beginning of the addition of the above mixture the monomers were added in the form of an emulsion (emulsifier: Dowfax 2A1, 45% strength in water) over a period of 3 hours. Thereafter 42 g of styrene, without emulsifier, were added over 10 minutes and following the addition of 2.8 g of 25% strength ammonia solution the dispersion was held at 80° C. for a further 15 minutes (2nd stage, swelling polymerization).

Additionally thereafter a chemical deodorization was carried out with 14 g of 10% strength tertiary-butyl hydroperoxide, 0.175 g of 4% strength Diisolvine I, and 9.31 g of 10% strength Rongalit C solution (80° C., 120 minutes). After cooling to room temperature the solids content was 61% by weight and the average particle size was 300 nm; the pH was between 6 and 7.

TABLE 1
Composition in parts by weight

| | A1 | A2 | A3 | A4 |
|---|---|---|---|---|
| Water | 28.4 | 28.2 | 28.2 | 28.2 |
| Dowfax 2A1 | 1 | 1 | 1 | 1 |
| t-Dodecyl mercaptan | 0.05 | 0.05 | 0.05 | 0.05 |
| Acrylic acid | 1.5 | 1.5 | 1.5 | 1.5 |
| Ethylhexyl acrylate | 0 | 10 | 20 | 40 |
| Butyl acrylate | 92.5 | 82.5 | 72.5 | 52.5 |
| Styrene | 6 | 6 | 6 | 6 |

The parts by weight of the monomers total 100.

### B) Preparation of the PSA Formulations

To all polymers A1 to A4 and Acronal® V215 20 parts by weight of Snowtack (a rosin ester) were added (20 parts of Snowtack, 80 parts of polymer, solids).

All formulations additionally comprise 1 part by weight of Lumiten I-SC (flow control agent) per 100 parts by weight of the sum of polymer and Snowtack.

### C) Performance Tests

### Peel and Shear Strength

Paper (Herma paper, 80 g/m²) was coated with the formulation (18 g/m² dry, drying at 90° C. for 3 minutes). (transfer method)

Subsequently the peel strength (adhesion) and shear strength (cohesion) were determined.

The coated backing was cut into test strips 25 mm wide. To determine the shear strength the test strips were bonded with a bond area of 25 mm² to a V2A stainless steel test panel, rolled on once with a roller weighing 1 kg, stored for 10 minutes (under standard conditions, 50% relative humidity, 1 bar, 23° C.) and subsequently loaded in suspended state with a 1 kg weight (under standard conditions and alternatively at 70° C.). The measure of the shear strength was the time taken for the weight to fall; in each case the average from 3 measurements was calculated.

For the determination of the peel strength (adhesion) a 2.5 cm wide test strip was adhered in each case to a steel test element and was rolled on once using a roller weighing 1 kg. After 20 minutes or 24 hours of storage under standard conditions it was clamped by one end into the upper jaws of a tensile-elongation testing apparatus. The adhesive strip was peeled from the test area at an angle of 180° and a speed of 300 mm/min; in other words, the adhesive strip was bent over and peeled off parallel to the metal test panel, and the force required to accomplish this was measured. The measure of the peel strength was the force in N/2.5 cm which resulted as the average value from five measurements. The test was likewise carried out under standard conditions.

### Loop Tack Test:

A loop was formed from the test strip and the adhesive-bearing side was contacted with a glass surface. Thereafter a determination was made of the maximum force required to peel the loop from the glass surface (peel speed 300 mm/min).

### Mandrel Test

A glass test rod circular in cross section (diameter: 1 cm) was wrapped round and adhered with a test strip cut to the appropriate length. After one week an examination was made of the extent to which the adhesive strip has come away, i.e., to which the bond has come apart. The figure reported is the total length of that portion of the test strip which is no longer attached to the glass rod (in mm).

TABLE

| | % by | Peel strength | | | Cohesion | | |
|---|---|---|---|---|---|---|---|
| | weight | | Poly- | Loop | (hours) | | |
| | EHO | Steel | ethylene | value | 23° C. | 70° C. | Mandrel |
| A1 | 0 | 22.1 | 15.7 | 9.9 | 12 | 1.5 | 1 |
| A2 | 10 | 20.9 | 17.4 | 9.5 | 18 | 1.3 | 1 |
| A3 | 20 | 22.3 | 18.8 | 9.4 | 21 | 0.9 | 2 |
| A4 | 40 | 19.7 | 12.6 | 10.5 | 9 | 0.5 | 5 |
| V215* | | 21.8 | 16.6 | 10.8 | 20 | 0.5 | 1 |

*Acronal ® V215, a polymer from BASF for PSAs

1. A pressure-sensitive adhesive comprising a polymer obtainable by free-radical polymerization and synthesized from
a) 70% to 99% by weight of n-butyl acrylate
b) 1% to 30% by weight of ethylhexyl acrylate
c) 0 to 5% by weight of an ethylenically unsaturated acid and
d) 0 to 20% by weight of at least one further monomer, from which vinyl acetate is excluded.

2. The pressure-sensitive adhesive according to claim 1, wherein the polymer is synthesized from
a) 75% to 95% by weight of n-butyl acrylate
b) 5% to 25% by weight of ethylhexyl acrylate
c) 0 to 5% by weight of an ethylenically unsaturated acid and
d) 0 to 5% by weight of at least one further monomer, from which vinyl acetate is excluded.

3. The pressure-sensitive adhesive according to claim 1, wherein the polymer is synthesized from
a) 75% to 94.5% by weight of n-butyl acrylate
b) 5% to 24.5% by weight of ethylhexyl acrylate
c) 0.5% to 5% by weight of an ethylenically unsaturated acid and
d) 0 to 10% by weight of at least one further monomer, from which vinyl acetate is excluded.

4. The pressure-sensitive adhesive according to claim 1, wherein the polymer is synthesized from
a) 80% to 89% by weight of n-butyl acrylate
b) 10% to 19% by weight of ethylhexyl acrylate
c) 1% to 2% by weight of an ethylenically unsaturated acid and
d) 0 to 5% by weight of at least one further monomer, from which vinyl acetate is excluded.

5. The pressure-sensitive adhesive according to claim 1, wherein the polymer is an emulsion polymer.

6. A self-adhesive article coated with a pressure-sensitive adhesive according to claim 1.

7. The self-adhesive article according to claim 6, which is a label.

8. The self-adhesive article according to claim 7, which is a paper label.

9. A method of printing a self-adhesive article with a laser printer, said self-adhesive article being an article according to claim 6.
